(19) United States
(12) Patent Application Publication
(10) Pub. No.: US 2017/0178252 A1
(43) Pub. Date: Jun. 22, 2017

(54) PERSONALIZED KNOWLEDGE EMAIL

(71) Applicant: LinkedIn Corporation, Mountain View, CA (US)

(72) Inventors: Minal Mehta, Belmont, CA (US); Prachi Gupta, San Mateo, CA (US); Félix Joseph Étienne Pageau, San Francisco, CA (US); Alexandre Patry, Pleasanton, CA (US); Jeffrey Douglas Gee, San Francisco, CA (US); Jeffrey Chow, South San Francisco, CA (US); Heloise Hwawen Logan, Sunnyvale, CA (US); Luke John Duncan, San Francisco, CA (US); Evan Farina, San Francisco, CA (US)

(21) Appl. No.: 14/975,673

(22) Filed: Dec. 18, 2015

(51) Int. Cl. G06Q 50/00; G06Q 10/10; H04L 12/58

(52) U.S. Cl. CPC G06Q 50/01; H04L 51/046; H04L 51/16; H04L 51/12; H04L 51/32; G06Q 10/1053

(57) ABSTRACT

A system, a machine-readable storage medium storing instructions, and a computer-implemented method are directed to a Digest Engine that identifies a feature(s) that is predictive of relevance, to a target member account in a professional social network, of content from a member group(s) to which the target member account is subscribed. Based on the feature(s), the Digest Engine determines a portion(s) of relevant content created amongst respective member accounts subscribed to the member group(s). The Digest Engine generates a persistent message providing access to the portion(s) of relevant content. The Digest Engine sends the persistent message to the target member account.

### TECHNICAL FIELD

The present disclosure generally relates to data processing systems. More specifically, the present disclosure relates to methods, systems and computer program products for identifying and providing access to relevant content.

### BACKGROUND

A social networking service is a computer- or web-based application that enables users to establish links or connections with persons for the purpose of sharing information with one another. Some social networking services aim to enable friends and family to communicate with one another, while others are specifically directed to business users with a goal of enabling the sharing of business information. For purposes of the present disclosure, the terms “social network” and “social networking service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks”).

With many social networking services, members are prompted to provide a variety of personal information, which may be displayed in a member's personal web page. Such information is commonly referred to as personal profile information, or simply “profile information”, and when shown collectively, it is commonly referred to as a member's profile. For example, with some of the many social networking services in use today, the personal information that is commonly requested and displayed includes a member's age, gender, interests, contact information, home town, address, the name of the member's spouse and/or family members, and so forth. With certain social networking services, such as some business networking services, a member's personal information may include information commonly included in a professional resume or curriculum vitae, such as information about a person's education, employment history, skills, professional organizations, and so on. With some social networking services, a member's profile may be viewable to the public by default, or alternatively, the member may specify that only some portion of the profile is to be public by default. Accordingly, many social networking services serve as a sort of directory of people to be searched and browsed.

### DESCRIPTION OF THE DRAWINGS

Some embodiments are illustrated by way of example and not limitation in the figures of the accompanying drawings in which:

FIG. 1 is a block diagram illustrating a client-server system, in accordance with an example embodiment;

FIG. 2 is a block diagram showing functional components of a professional social network within a networked system, in accordance according to embodiments described herein.

FIG. 3 is a flowchart illustrating a method of generating a persistent message having conversation content that is relevant to a target account, according to embodiments described herein;

FIG. 4 is a block diagram showing a target member account subscribed to a plurality of member groups, according to some embodiments;

FIG. 5A is a block diagram showing a first portion of a persistent message, according to some embodiments;

FIG. 5B is a block diagram showing a second portion of the persistent message, according to some embodiments;

FIG. 6 is a block diagram showing example components of a Digest Engine, according to some embodiments;

FIG. 7 is a block diagram of an example computer system on which methodologies described herein may be executed, in accordance with an example embodiment.

### DETAILED DESCRIPTION

A system, a machine-readable storage medium storing instructions, and a computer-implemented method are directed to a Digest Engine that identifies a feature(s) that is predictive of relevance, to a target member account in a professional social network, of content from a member group(s) to which the target member account is subscribed. Based on the feature(s), the Digest Engine determines a portion(s) of relevant content created amongst respective member accounts subscribed to the member group(s). The Digest Engine generates a persistent message providing access to the portion(s) of relevant content. The Digest Engine sends the persistent message to the target member account.

In one embodiment, a target member account subscribes to multiple member groups, whereby each member group has one or more active conversations (or discussions) occurring amongst the subscriber member accounts. The Digest Engine identifies conversations from each of the member groups that are relevant to the target member account and generates an email message for the target member account. The email message includes a selectable link to each relevant conversation. The Digest Engine sends the email message to the target member account. The email message acts as a digest of conversations that the target account will most likely find interesting. It is understood that the Digest Engine generates the email message for the target account on a daily, weekly or monthly basis.

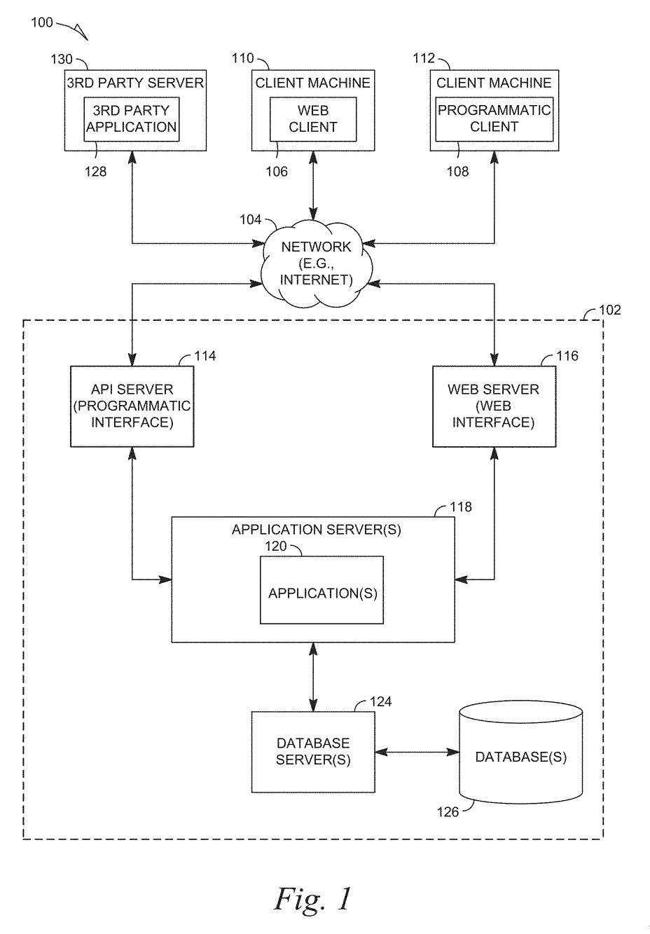

Turning now to FIG. 1, FIG. 1 is a block diagram illustrating a client-server system, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102. In some embodiments, the networked system 102 may comprise functional components of a professional social network.

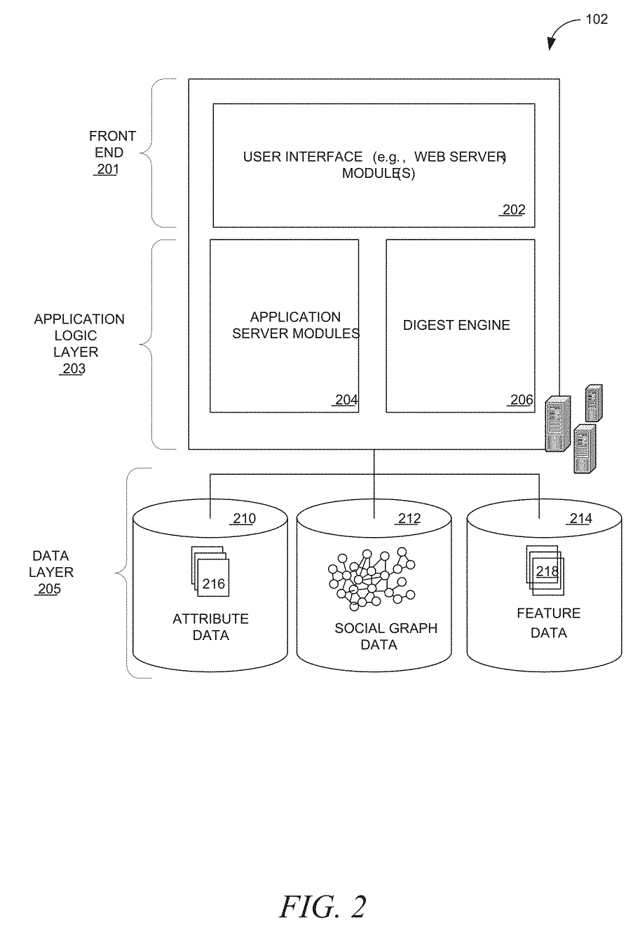

FIG. 2 is a block diagram showing functional components of a professional social network within the networked system 102, in accordance with an example embodiment.

As shown in FIG. 2, the professional social network may be based on a three-tiered architecture, consisting of a front-end layer 201, an application logic layer 203, and a data layer 205. In some embodiments, the modules, systems, and/or engines shown in FIG. 2 represent a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 2. However, one skilled in the art will readily recognize that various additional functional modules and engines may be used with a professional social network, such as that illustrated in FIG. 2, to facilitate additional functionality that is not specifically described herein. Furthermore, the various functional modules and engines depicted in FIG. 2 may reside on a single server computer, or may be distributed across several server computers in various arrangements. Moreover, although a professional social network is depicted in FIG. 2 as a three-tiered architecture, the inventive subject matter is by no means limited to such architecture. It is contemplated that other types of architecture are within the scope of the present disclosure.

As shown in FIG. 2, in some embodiments, the front-end layer 201 comprises a user interface module (e.g., a web server) 202, which receives requests and inputs from various client-computing devices, and communicates appropriate responses to the requesting client devices. For example, the user interface module(s) 202 may receive requests in the form of Hypertext Transport Protocol (HTTP) requests, or other web-based, application programming interface (API) requests.

In some embodiments, the application logic layer 203 includes various application server modules 204, which, in conjunction with the user interface module(s) 202, generates various user interfaces (e.g., web pages) with data retrieved from various data sources in the data layer 205. In some embodiments, individual application server modules 204 are used to implement the functionality associated with various services and features of the professional social network. For instance, the ability of an organization to establish a presence in a social graph of the social network service, including the ability to establish a customized web page on behalf of an organization, and to publish messages or status updates on behalf of an organization, may be services implemented in independent application server modules 204. Similarly, a variety of other applications or services that are made available to members of the social network service may be embodied in their own application server modules 204.

As shown in FIG. 2, the data layer 205 may include several databases, such as a database 210 for storing profile data 216, including both member profile attribute data as well as profile attribute data for various organizations. Consistent with some embodiments, when a person initially registers to become a member of the professional social network, the person will be prompted to provide some profile attribute data such as, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This attribute data 216 may be stored, for example, in the database 210. Similarly, when a representative of an organization initially registers the organization with the professional social network the representative may be prompted to provide certain information about the organization. This information may be stored as attribute data 216 as well, for example, in the database 210, or another database (not shown). With some embodiments, the attribute data 216 may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or a seniority level within a particular company. With some embodiments, importing or otherwise accessing data from one or more externally hosted data sources may enhance attribute data 216 for both members and organizations. For instance, with companies in particular, financial data may be imported from one or more external data sources, and made part of a company's profile.

The attribute data 216 may also include information regarding settings for members of the professional social network. These settings may comprise various categories, including, but not limited to, privacy and communications. Each category may have its own set of settings that a member may control. The attribute data 216 may also include attributes of one or more member groups and attributes of various conversations (or discussions) currently occurring between member accounts subscribed to a member group.

Once registered, a member may invite other members, or be invited by other members, to connect via the professional social network. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, may be stored and maintained as social graph data within a social graph database 212.

The professional social network may provide a broad range of other applications and services that allow members the opportunity to share and receive information, often customized to the interests of the member. For example, with some embodiments, the professional social network may include a photo sharing application that allows members to upload and share photos with other members. With some embodiments, members may be able to self-organize into groups, or interest groups, organized around a subject matter or topic of interest. With some embodiments, the professional social network may host various job listings providing details of job openings with various organizations.

As members interact with the various applications, services and content made available via the professional social network, the members' behaviour (e.g., content viewed, links or member-interest buttons selected, etc.) may be monitored and information 218 concerning the member's activities, profile completeness, level of engagement, level of usage and behaviour may be stored, for example, as indicated in FIG. 2, by the database 214. This information, or feature data 218, may be used to classify the member as being in various categories and may be further considered as an attribute of the member. For example, if the member performs frequent searches of job listings, thereby exhibiting behaviour indicating that the member is a likely job seeker, this information 218 can be used to classify the member as being a job seeker. This classification can then be used as a member profile attribute for purposes of enabling others to target the member for receiving messages, status updates and/or a list of ranked premium and free job postings. In addition, the feature data 218 includes learned weights coefficients that correspond to attributes used to determine the relevance of content as described herein.

In some embodiments, the professional social network provides an application programming interface (API) module via which third-party applications can access various services and data provided by the professional social network. For example, using an API, a third-party application may provide a user interface and logic that enables an authorized representative of an organization to publish messages from a third-party application to a content hosting platform of the professional social network that facilitates presentation of activity or content streams maintained and presented by the professional social network. Such third-party applications may be browser-based applications, or may be operating system-specific. In particular, some third-party applications may reside and execute on one or more mobile devices (e.g., a smartphone, or tablet computing devices) having a mobile operating system.

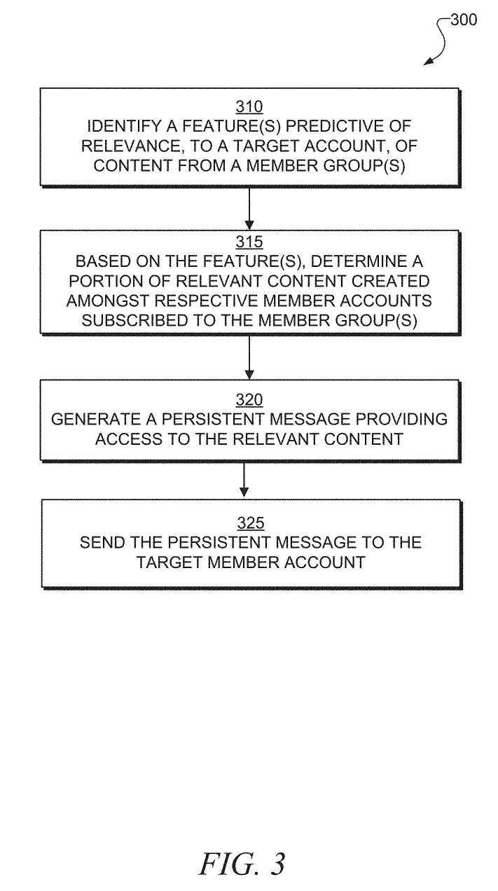

The data in the data layer 205 may be accessed, used, and adjusted by the Digest Engine 206 as will be described in more detail below in conjunction with FIGS. 3-6. Although the Digest Engine 206 is referred to herein as being used in the context of a professional social network, it is contemplated that it may also be employed in the context of any website or online services, including, but not limited to, content sharing sites (e.g., photo- or video-sharing sites) and any other online services that allow users to have a profile and present themselves or content to other users. Additionally, although features of the present disclosure are referred to herein as being used or presented in the context of a web page, it is contemplated that any user interface view (e.g., a user interface on a mobile device or on desktop software) is within the scope of the present disclosure.

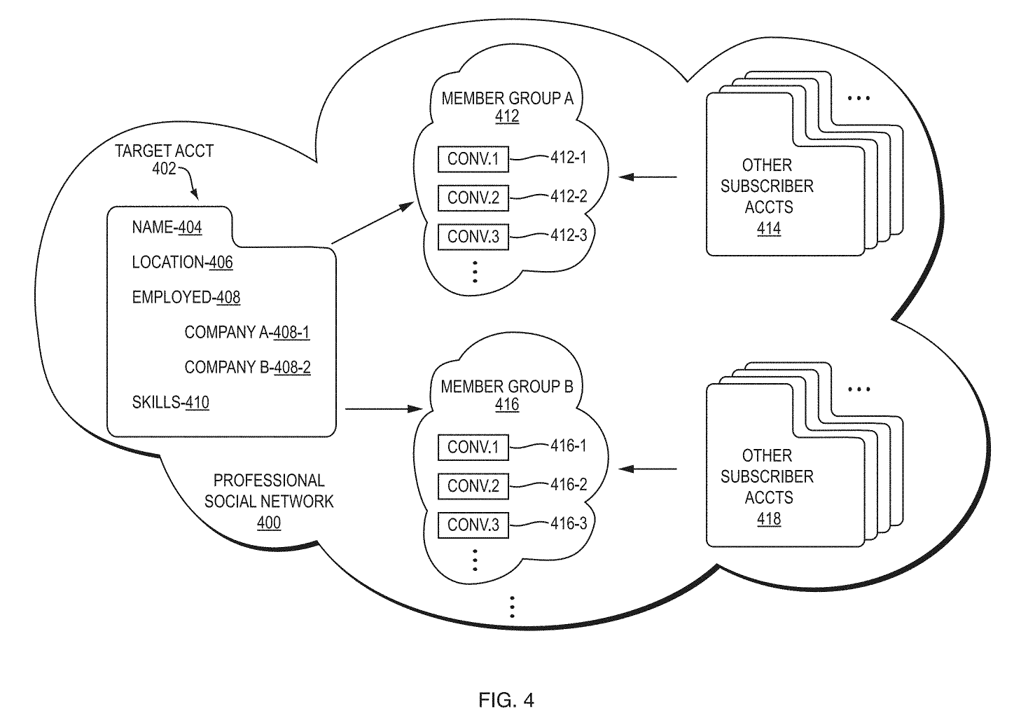

FIG. 3 is a flowchart illustrating a method 300 of generating a persistent message having conversation content that is relevant to a target account, according to embodiments described herein. The operations 310, 315, 320, 325 of the method 300 are discussed below in reference to aspects of the Digest Engine 206 illustrated by FIG. 4

FIG. 4 is a block diagram showing a target member account subscribed to a plurality of member groups, according to some embodiments. A target account 402 in a professional social network 400 has a plurality of attributes, such as name 404 and location 406. In an employment history section 408, the target account 402 includes a current employer “Company A” 408-1 and a previous employer “Company B” 408-2. The target account 402 also includes a skills section 410, which includes one or more skills attributes. It is understood that the target account 402 can also include attributes identifying education (i.e. degrees earned), certification(s), endorsements received from other accounts, and recommendations received from other accounts.

The target account 402 is subscribed to a plurality of member groups 412, 416. Member Group A 412 has additional subscriber accounts 414 and Member Group B 416 has additional subscriber accounts 416. There are a plurality of conversations 412-1, 412-2, 412-3 occurring within Member Group A and there are a plurality of conversations 416-1, 416-2, 416-3 occurring within Member Group B.

At operation 310, the Digest Engine 206 identifies a feature predictive of relevance, to a target account 402, of content from a member group(s) 412, 416.

For example, the Digest Engine 206 utilizes regression techniques to process features and also generate and continually update learned weights (or trained coefficients) for scoring features. The features are based on an attribute(s) of the target account 402 and/or an attribute(s) of the given conversation 412-1, 412-2, 412-2 . . . , 416-1, 416-2, 412-3 . . . . In example embodiment, such features are based on one or more attributes of a group to which multiple account are subscribed and/or one or more attributes of an author (or initiating member account) or a particular conversation. In another example embodiment, one or more features are based on the target account's 402 interaction history with an author of a conversation. For example, if previous social network activity the target account 402 and a given author of a conversation in a group to which the target account 402 is 402 meets a threshold level of interaction, a value for a learned weight will reflect such previous social network activity between the target account 402 and the given author. When the Digest Engine 206 scores the given author's given conversation, the value of the learned weight will have an effect such that the Digest Engine 206 will determine the given conversation to be highly-relevant to the target account 402.

In one embodiment, a first feature represents one or more attributes of a target account transformed according to a logarithmic function. A first learned weight (or first trained coefficient) is applied to the first feature in order to generate a score for the target account. A target account's attribute can be information on a profile page such as industry, gender, location, skills, endorsements, a latent topic of the target account's profile (as determined for example, by a Latent Dirichlet Allocation [LDA]), and/or level of target account's career/job seniority. A second feature represents one or more attributes of the given conversation present in the member group. For example, the second feature can be a conversion the one or more attributes of the given conversation into a population quintile. A second learned weight (or second trained coefficient) is applied to the second feature in order to generate a score for the given conversation. A conversation attribute can be the age of conversation, number of member group subscribers, number of conversation comments, number of conversation views, number of conversation likes and/or how recently the target account contributed to the conversation.

It is understood that each attribute may have its own corresponding learned weights (or trained coefficients) and that a feature can itself be a cross-product (or aggregate) of multiple features. It is further noted that a particular learned weights (or trained coefficients) for a type of attribute is continually updated by the Digest Engine 206 based at least on tracking events (i.e. views, clicks, selections) from a plurality of accounts (or conversations) within the professional social network that have that type of attribute.

At operation 315, the Digest Engine 206 determines a portion of relevant content created amongst respective member accounts 412, subscribed to the member group(s) 412, 416.

The Digest Engine 206 determines a relevance score for each conversation 412-1, 412-2, 412-3 . . . , 416-1, 416-2, 416-3 . . . with respect to the target account 402. In one embodiment, the Digest Engine 206 scores a given conversation's attributes according to respective learned weights (or trained coefficients) and scores the target account's 402 according to respective learned weights (or trained coefficients). It is understood that the learned weights (or trained coefficients) are continually updated according to various regression techniques.

For example, the Digest Engine 206s determines a cross-product score for the given conversation based on the cross-product of the given conversation's scored attributes and the target account's scored attributes. To further determine the given conversation's relevance score, the Digest Engine 206 adjusts the cross-product score according to one or more popularity factors. Popularity factors can be at least one of: a number of views, comments, ratings, likes and/or subscriber accounts active in the conversations. It is understood that the popularity factors can include recency constraints, such as number of views in the past 24 hours, number of new comments during the last week, or number of views since the target account 402 added content to (or viewed) the given conversation.

The Digest Engine 206 applies diversity factors to the given conversation. For example, if the given conversation was already included in a previously persistent message sent to the target account 402 within the last three days, the Digest Engine 206 disqualifies the given conversation from being a candidate for inclusion in the persistent message. According to another example, if at least 3 other conversations from the same member group have a higher relevance score than the given conversation, the Digest Engine 206 disqualifies the given conversation from being a candidate for inclusion in the persistent message. According to another example, if the given conversation has a conversation age greater than 3 months, the Digest Engine 206 disqualifies the given conversation from being a candidate for inclusion in the persistent message.

The Digest Engine 206 ranks all scored conversations that satisfy the diversity factors. The Digest Engine 206 selects a portion of the ranked conversations for inclusion in the persistent message. For example, the Digest Engine 206 filters the ranked conversations based on rank to select the top 10 ranked conversations for inclusion in the persistent message to be sent to the target account 402.

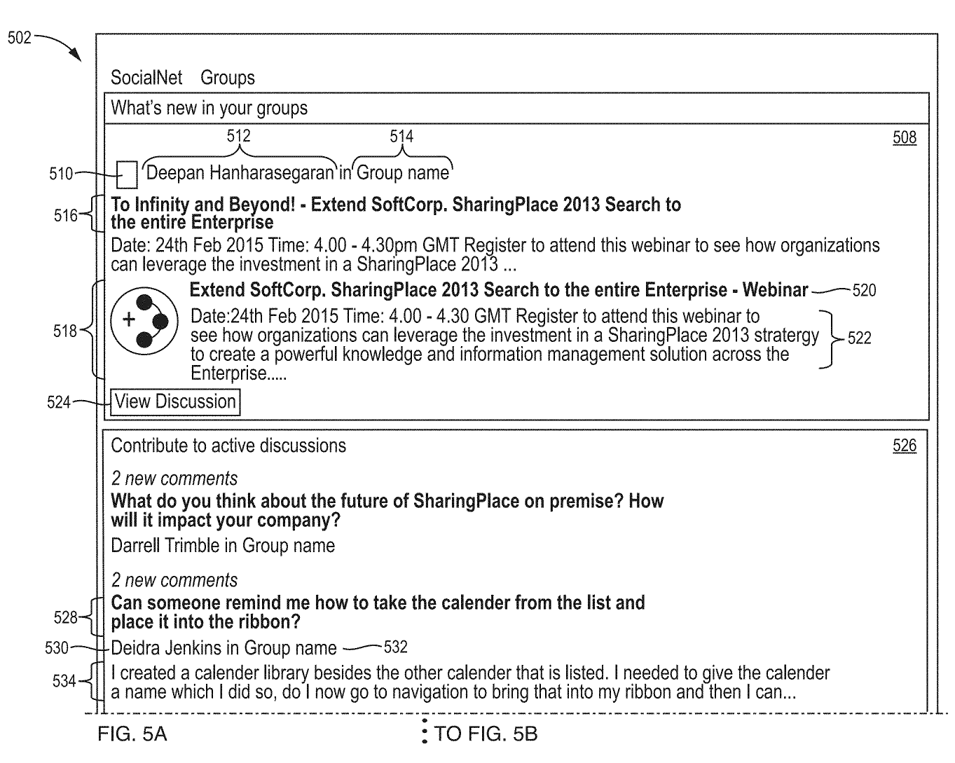

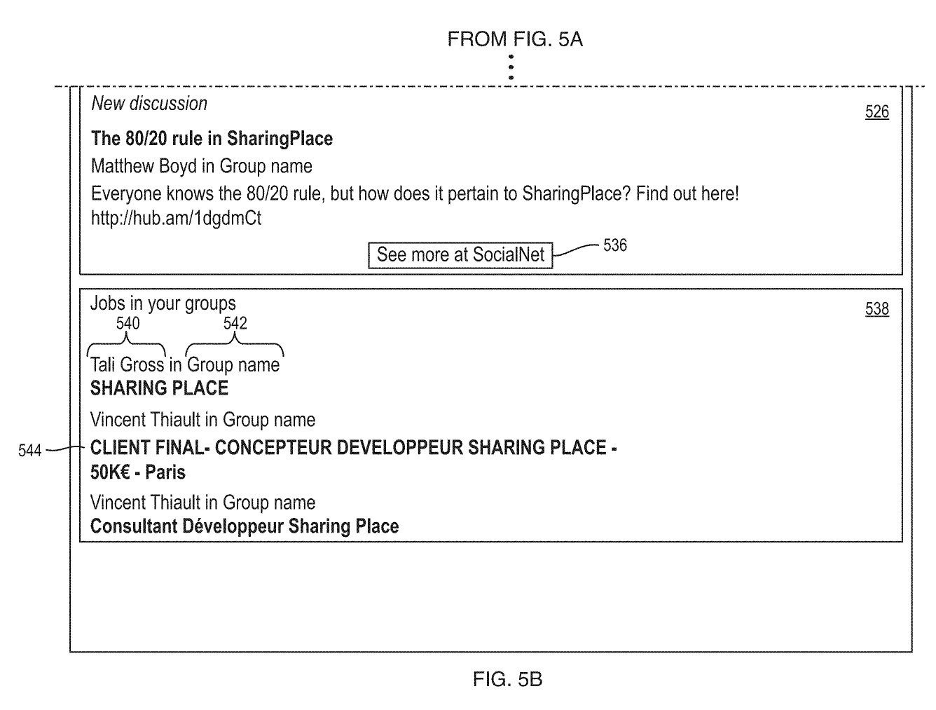

At operation 320, the Digest Engine 206 generates a persistent message providing access to the relevant content. FIGS. 5A-5B illustrate respective portions of a persistent message generated by the Digest Engine 206.

At operation 325, the Digest Engine 206 sends the persistent message to the target account 402.

FIG. 5A is a block diagram showing a first portion of a persistent message, according to some embodiments.

The Digest Engine 206 generates a persistent message 502 (such as an email) to be sent to the target account 402. The persistent message 502 includes a section 508 for the most relevant conversation. The most relevant conversation is related to an article accessible on the professional social network 400. In section 508, the Digest Engine 206 includes a group image 510 that represents the member group in which the most relevant conversation is occurring. The Digest Engine 206 includes the name 512 of the subscriber account who initiated the most relevant conversation and the name 514 of the member group in which the most relevant conversation is occurring.

The Digest Engine 206 further includes, in section 508 of the persistent message 502, the subject 516 (or title) of the most relevant conversation. Upon receiving selection of the subject 516, the Digest Engine 206 triggers access of the most relevant conversation, which pertains to an article. The Digest Engine 206 includes an image 518 scraped from the article. Upon selection of the image 518, the Digest Engine 206 triggers access of the article. The Digest Engine 206 further includes the article's subject 520 and a summary 522 of the article as well. Selection of the subject 520 or the summary 522 trigger access of the article. In addition, the Digest Engine 206 further includes a button 524 in section 508 that, upon selection, triggers access by the target account 402 of the most relevant conversation.

The Digest Engine 206 generates section 526 of the persistent message 502. The Digest Engine 206 includes, in section 526, information and links to other relevant conversations selected for inclusion in the persistent message 502. For example, the Digest Engine 206 includes a subject 528 and an author 530 of a given relevant conversation. In one embodiment, selection of the subject 528 triggers access of the given relevant conversation. The Digest Engine 206 further includes a name 532 of a member group in which the given relevant conversation occurs. In one embodiment, selection of the name 532 triggers access of the member group in which the given relevant conversation occurs. The Digest Engine 206 includes a summary 534 of a respective comment in the given relevant conversation. In one embodiment, selection of the summary 534 triggers access of the respective comment

FIG. 5B is a block diagram showing a second portion of the persistent message, according to some embodiments.

As illustrated in FIG. 5B, section 526 includes a selectable functionality 536 for accessing a portion of the professional social network 400. For example, selection of the functionality 536 triggers access of one or more of the member groups to which the target account 402 is subscribed. In addition, the Digest Engine 206 generates section 538 for inclusion in the persistent message 502. Section 538 provides for descriptions of a job posting(s) from one or more member groups to which the target account 402 is subscribed. Section 538 includes a name 540 of a respective account subscribed to a member group 542. In one embodiment, selection of the name 540 triggers access of a profile page of the respective account. In one embodiment, selection of the member group 542 triggers access of the member group in the professional social network 400. A link 544 to a job posting submitted by the respective account is included as well.

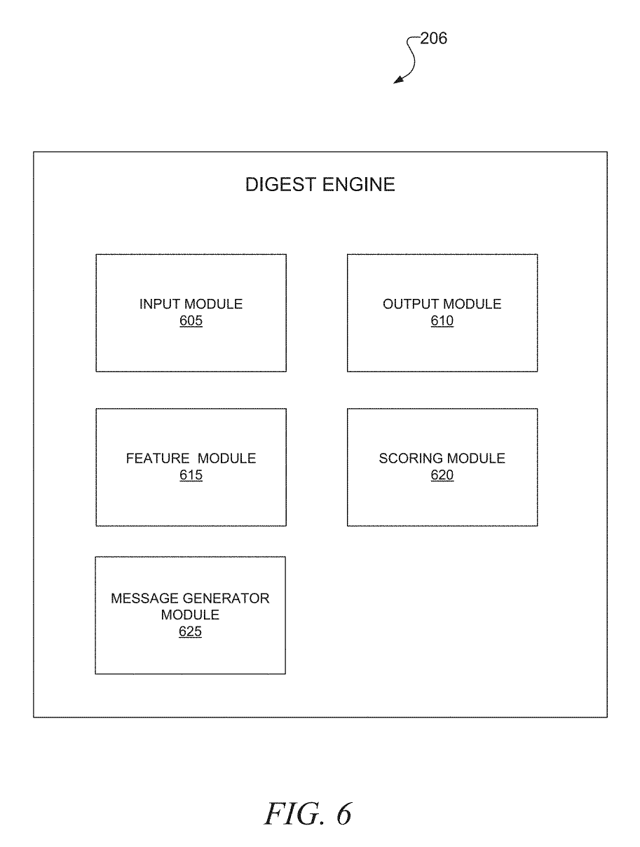

FIG. 6 is a block diagram showing example components of a Digest Engine 206, according to some embodiments.

The input module 605 is a hardware-implemented module that controls, manages and stores information related to any inputs from one or more components of system 102 as illustrated in FIG. 1 and FIG. 2.

The output module 610 is a hardware-implemented module that controls, manages and stores information related to which sends any outputs to one or more components of system 100 of FIG. 1 (e.g., one or more client devices 110, 112, third party server 130, etc.). In some embodiments, the output is one or more persistent messages.

The feature module 615 is a hardware implemented module which manages, controls, stores, and accesses information related to determining one or more features and learned weights (or trained coefficients) according to regression techniques.

The scoring module 620 is a hardware-implemented module which manages, controls, stores, and accesses information related to determining a relevance score for content based at least on features of a target account and a conversation of a member group. The scoring module 620 filters scored conversations according to diversity factors and ranks the scored conversations. The scoring module 620 selects a subset of the ranked conversation for inclusion in a persistent message.

The message generator module 625 is a hardware-implemented module which manages, controls, stores, and accesses information related to generating a persistent message to be sent to a target account.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

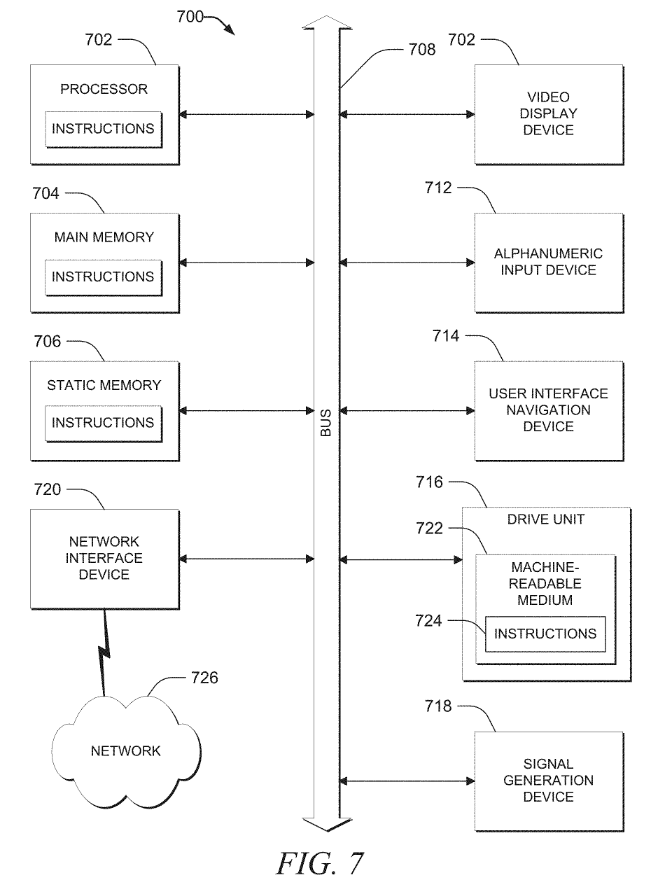

FIG. 7 is a block diagram of a machine in the example form of a computer system 700 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 700 includes a processor 702 (e.g., a central processing unit (CPU), a graphics processing unit (GPU) or both), a main memory 704, and a static memory 706, which communicate with each other via a bus 708. Computer system 700 may further include a video display device 710 (e.g., a liquid crystal display (LCD) or a cathode ray tube (CRT)). Computer system 700 also includes an alphanumeric input device 712 (e.g., a keyboard), a user interface (UI) navigation device 714 (e.g., a mouse or touch sensitive display), a disk drive unit 716, a signal generation device 718 (e.g., a speaker) and a network interface device 720.

Disk drive unit 716 includes a machine-readable medium 722 on which is stored one or more sets of instructions and data structures (e.g., software) 724 embodying or utilized by any one or more of the methodologies or functions described herein. Instructions 724 may also reside, completely or at least partially, within main memory 704, within static memory 706, and/or within processor 702 during execution thereof by computer system 700, main memory 704 and processor 702 also constituting machine-readable media.

While machine-readable medium 722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present technology, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

Instructions 724 may further be transmitted or received over a communications network 726 using a transmission medium. Instructions 724 may be transmitted using network interface device 720 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the technology. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A computer system comprising:
a processor;
a memory device holding an instruction set executable on the processor to cause the computer system to perform operations comprising:
generating, according to a plurality of instructions representative of a logistic regression model, respective types of member account features and respective types of conversation features, wherein each type of member account feature and each type of conversation feature has an assigned updateable regression coefficient, wherein each updateable regression coefficient represents how predictive its corresponding assigned type of feature is in determining relevance of a conversation active in a professional social network to a given member account;
identifying presence of at least one of a particular type of member account feature and presence of at least one of a particular type of conversation feature between a target member account and a particular conversation active amongst member accounts in a member group to which the target member account in currently subscribed;
based on the at least one present type of member account feature and the at least one present type of conversation feature, predicting, according to the logistic regression model, a relevance of the particular conversation to the target member account;
based a predicted relevance of the particular conversation, generating a persistent message providing access to of the particular conversation; and
sending the persistent message to the target member account.

2. (canceled)

3. The computer system of claim 1, wherein a first type of predefined conversation feature comprises a particular conversation topic.

4. The computer system of claim 1, wherein the particular conversation comprises member-generated content received within the professional social network from at least one of the respective member accounts subscribed to the member group.

5. The computer system of claim 1, further comprises:
identifying presence of the at least one particular type of member account feature and presence of the at least one particular type of conversation feature between the target member account and an additional conversation active in the member group;
based on the at least one present type of member account feature and the at least one present conversation feature, predicting, according to the logistic regression model, the additional conversation is relevant to the target member account; and
excluding the additional conversation from the persistent message based on an age of the additional conversation.

6. The computer system of claim 1, further comprises:
identifying presence of the at least one particular type of member account feature and presence of the at least one particular type of conversation feature between the target member account and an additional conversation active in the member group;
based on the at least one present type of member account feature and the at least one present conversation feature, predicting, according to the logistic regression model, the additional conversation is relevant to the target member account; and
determining the additional conversation was included in a previous persistent message sent to the target member account during a threshold time range; and
excluding the additional conversation from the persistent message based on inclusion of the additional conversation in the previous persistent message.

7. The computer system of claim 1, further comprises:
identifying presence of the at least one particular type of member account feature and presence of the at least one particular type of conversation feature between the target member account and each of a plurality of conversation active in the member group;
based on the at least one present type of member account feature and the at least one present conversation feature, predicting, according to the logistic regression model, each conversation in the plurality of conversation is relevant to the target member account; and
applying a conversation-per-member-group cap to the plurality of conversations; and
excluding a subset of the plurality of conversations from inclusion in the persistent message based on the conversation-per-member-group cap.

8.-20. (canceled)

21. A computer-implemented method comprising:
generating, according to a plurality of instructions representative of a logistic regression model, respective types of member account features and respective types of conversation features, wherein each type of member account feature and each type of conversation feature has an assigned updateable regression coefficient, wherein each updateable regression coefficient represents how predictive its corresponding assigned type of feature is in determining relevance of a conversation active in a professional social network to a given member account;
identifying, via at least one hardware processor, presence of at least one of a particular type of member account feature and presence of at least one of a particular type of conversation feature between a target member account and a particular conversation active amongst member accounts in a member group to which the target member account in currently subscribed;
based on the at least one present type of member account feature and the at least one present type of conversation feature, predicting, according to the logistic regression model, a relevance of the particular conversation to the target member account;
based a predicted relevance of the particular conversation, generating a persistent message providing access to the particular conversation; and
sending the persistent message to the target member account.

22. The computer-implemented method of claim 21, wherein a first type of predefined conversation feature comprises a particular conversation topic.

23. The computer-implemented method of claim 21, wherein the particular conversation comprises member-generated content received within the professional social network from at least one of the respective member accounts subscribed to the member group.

24. The computer-implemented method of claim 21, further comprises:
identifying presence of the at least one particular type of member account feature and presence of the at least one particular type of conversation feature between the target member account and an additional conversation active in the member group;
based on the at least one present type of member account feature and the at least one present conversation feature, predicting, according to the logistic regression model, the additional conversation is relevant to the target member account; and
excluding the additional conversation from the persistent message based on an age of the additional conversation.

25. The computer-implemented method of claim 21, further comprises:
identifying presence of the at least one particular type of member account feature and presence of the at least one particular type of conversation feature between the target member account and an additional conversation active in the member group;
based on the at least one present type of member account feature and the at least one present conversation feature, predicting, according to the logistic regression model, the additional conversation is relevant to the target member account; and
determining the additional conversation was included in a previous persistent message sent to the target member account during a threshold time range; and
excluding the additional conversation from the persistent message based on inclusion of the additional conversation in the previous persistent message.

26. The computer-implemented method of claim 21, further comprises:
identifying presence of the at least one particular type of member account feature and presence of the at least one particular type of conversation feature between the target member account and each of a plurality of conversation active in the member group;
based on the at least one present type of member account feature and the at least one present conversation feature, predicting, according to the logistic regression model, each conversation in the plurality of conversation is relevant to the target member account; and
applying a conversation-per-member-group cap to the plurality of conversations; and
excluding a subset of the plurality of conversations from inclusion in the persistent message based on the conversation-per-member-group cap.

27. A non-transitory computer-readable medium storing executable instructions thereon which, when executed by a processor, cause the processor to perform operations including:
generating, according to a plurality of instructions representative of a logistic regression model, respective types of member account features and respective types of conversation features, wherein each type of member account feature and each type of conversation feature has an assigned updateable regression coefficient, wherein each updateable regression coefficient represents how predictive its corresponding assigned type of feature is in determining relevance of a conversation active in a professional social network to a given member account;
identifying presence of at least one of a particular type of member account feature and presence of at least one of a particular type of conversation feature between a target member account and a particular conversation active amongst member accounts in a member group to which the target member account in currently subscribed;
based on the at least one present type of member account feature and the at least one present type of conversation feature, predicting, according to the logistic regression model, a relevance of the particular conversation to the target member account;
based a predicted relevance of the particular conversation, generating a persistent message providing access to the particular conversation; and
sending the persistent message to the target member account.

28. The non-transitory computer-readable medium of claim 27, wherein a first type of predefined conversation feature comprises a particular conversation topic.

29. The non-transitory computer-readable medium of claim 27, wherein the particular conversation comprises member-generated content received within the professional social network from at least one of the respective member accounts subscribed to the member group.

30. The non-transitory computer-readable medium of claim 27, further comprises:
identifying presence of the at least one particular type of member account feature and presence of the at least one particular type of conversation feature between the target member account and an additional conversation active in the member group;
based on the at least one present type of member account feature and the at least one present conversation feature, predicting, according to the logistic regression model, the additional conversation is relevant to the target member account; and
excluding the additional conversation from the persistent message based on an age of the additional conversation.

31. The non-transitory computer-readable medium of claim 27, further comprises:
identifying presence of the at least one particular type of member account feature and presence of the at least one particular type of conversation feature between the target member account and an additional conversation active in the member group;
based on the at least one present type of member account feature and the at least one present conversation feature, predicting, according to the logistic regression model, the additional conversation is relevant to the target member account; and
determining the additional conversation was included in a previous persistent message sent to the target member account during a threshold time range; and
excluding the additional conversation from the persistent message based on inclusion of the additional conversation in the previous persistent message.

32. The non-transitory computer-readable medium of claim 27, further comprises:
identifying presence of the at least one particular type of member account feature and presence of the at least one particular type of conversation feature between the target member account and each of a plurality of conversation active in the member group;
based on the at least one present type of member account feature and the at least one present conversation feature, predicting, according to the logistic regression model, each conversation in the plurality of conversation is relevant to the target member account; and
applying a conversation-per-member-group cap to the plurality of conversations; and
excluding a subset of the plurality of conversations from inclusion in the persistent message based on the conversation-per-member-group cap.
